(19) United States
(12) Patent Application Publication
(10) Pub. No.: US 2008/0013206 A1
(43) Pub. Date: Jan. 17, 2008

(54) Reducing the obstruction of air flow through a bypass channel associated with a disk drive

(76) Inventors: Norbert A. Feliss, Sunnyvale, CA (US); Donald R. Gillis, San Jose, CA (US); Ferdinand Hendriks, Morgan Hill, CA (US)

Correspondence Address: WAGNER, MURABITO & HAO LLP, 123 Westridge Drive, Watsonville, CA, 95076, US

(21) Appl. No.: 11/486,883

(22) Filed: Jul. 14, 2006

(51) Int. Cl. G11B 33/14

(52) U.S. Cl. 360/97.02

(57) ABSTRACT

Embodiments of the present invention pertain to reducing the obstruction of air flow through a bypass channel associated with a disk drive. According to one embodiment, disk drive filtering system includes a selective filtering region, a pass-by filter, and a filter free region. The selective filtering region is disposed within a bypass channel. The pass-by filter is disposed within the selective filtering region and is used for filtering a first portion of the air that flows through the selective filtering region. The filter free region is disposed proximate to the pass-by filter. A second portion of the air is allowed to flow substantially unobstructed through the selective filtering region.

### TECHNICAL FIELD

Embodiments of the present invention relate to filtering the air in a disk drive. More specifically, embodiments of the present invention relate to filtering the air in a disk drive while at the same time reducing the obstruction of air flow through a bypass channel associated with the disk drives those results from filtering the air.

### BACKGROUND

Particles from outside of the disk drive can get into the disk drive or the particles can come from within the disk drive after manufacturing. In the latter case, the particles may come from parts wearing against each other or from lubricating oil that is inside of the disk drive, among other things. In order to store and read data, the read write head flies close to the surface of the disk. A particle that gets between the air bearing surface of the read write head and the surface of the disk can cause damage to the disk as well as the read write head. Thus, data can be permanently lost and the disk drive can be ruined.

Therefore, it has always been important to maintain as clean an environment inside the disk drive as possible. Typically, a filter has been placed inside of a disk drive in order to maintain a clean environment. FIG. 1 depicts a prior art disk drive with a conventional filter. The disk drive 110 includes a base casting 113, a motor hub assembly 130, a disk 112, actuator shaft 132, actuator arms 134, suspension assembly 137, a hub 140, rotary voice coil motor 150, a magnetic read write head 156, a slider 155.

The components are assembled into a base casting 113, which provides attachment and registration points for components and subassemblies. A plurality of suspension assemblies 137 (one shown) can be attached to the actuator arms 134 (one shown) in the form of a comb. A plurality of transducer heads or sliders 155 (one shown) can be attached respectively to the suspension assemblies 137. Sliders 155 are located proximate to the disk 112's surface 135 for reading and writing data with magnetic heads 156 (one shown). The rotary voice coil motor 150 rotates actuator arms 134 about the actuator shaft 132 in order to move the suspension assemblies 137 to the desired radial position on a disk 112. The desiccant 160 is typically placed near the voice coil motor 150. The actuator shaft 132, hub 140, actuator arms 134, and voice coil motor 150 may be referred to collectively as a rotary actuator assembly.

Data is recorded onto disk surfaces 135 in a pattern of concentric rings known as data tracks 136. Disk surface 135 is spun at high speed by means of a motor-hub assembly 130. Data tracks 136 are recorded onto spinning disk surfaces 135 by means of magnetic heads 156, which typically reside at the end of sliders 155.

FIG. 1 being a plan view shows only one head, slider and disk surface combination. One skilled in the art understands that what is described for one head-disk combination applies to multiple head-disk combinations, such as disk stacks (not shown). However, for purposes of brevity and clarity, FIG. 1 only shows on head and one disk surface.

The spinning of the disk 112 causes air to move inside of the disk drive 110. In order to position the read write head 156 at the appropriate location, it is important that the actuator 132 not be subjected to excessive air turbulence. One of the purposes of the bypass channel 168 is to reduce the amount of air that passes by the actuator 134. Air tends to flow along the bypass channel 168 as indicated by the arrows 170 rather than by the actuator 134, thus, reducing the amount of air turbulence that the actuator 134 is subjected to.

Since the read write head 156 flies close to the surface of the disk 112 any particle that comes between the read write head 156 and the surface 135 of the disk 112 could result in potentially permanent damage to the disk 112 and loss of data. Therefore, the conventional filter 172 is used for cleaning the air (also referred to herein as the “environment”) inside of the disk drive 110, thus, reducing the amount of particles inside of the disk drive 110. “Time to remove 90 percent of the particles” (also known as “T90”) is a common measurement for the ability of a filter to clean 90% of the particles out of the disk's environment. One skilled in the art understands that what is described for a disk drive with a single disk applies to a disk drive with multiple disks. The embodied invention is independent of the number of head disk combinations.

### SUMMARY OF THE INVENTION

Embodiments of the present invention pertain to reducing the obstruction of air flow through a bypass channel associated with a disk drive. According to one embodiment, disk drive filtering system includes a selective filtering region, a pass-by filter, and a filter free region. The selective filtering region is disposed within a bypass channel. The pass-by filter is disposed within the selective filtering region and is used for filtering a first portion of the air that flows through the selective filtering region. The filter free region is disposed proximate to the pass-by filter. A second portion of the air is allowed to flow substantially unobstructed through the selective filtering region.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a plan view of an HDD with cover and top magnet removed.

FIG. 2 depicts a conventional filter and a filter according to one embodiment of the present invention.

FIG. 3A depicts a conventional disk drive filtering system which obstructs the air flow through a bypass channel associated with a disk drive.

FIGS. 3B-3D depict disk drive filtering systems for reducing the obstruction of air flow through a bypass channel associated with a disk drive, according to one embodiment.

FIG. 4 depicts a disk drive for reducing obstruction of air flow through a bypass channel associated with the disk drive, according to one embodiment.

FIG. 5 depicts a flowchart describing a method of manufacturing a disk drive filtering system that reduces obstruction of air flow through a bypass channel associated with a disk drive, according to one embodiment of the present invention.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

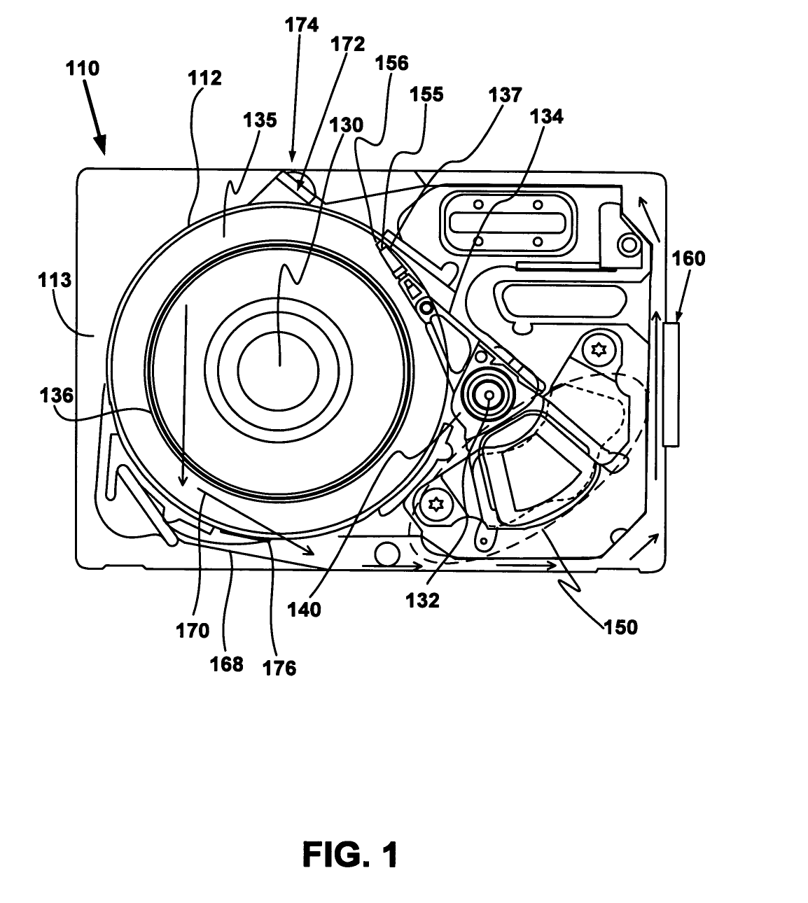

There are several problems with the conventional air filter 172 as depicted in FIG. 1. First, it is important to have the air that flows 170 along the bypass channel 168 to re-enter the spinning disk 112 tangentially and at approximately the speed that the disk 135 is spinning. However, the air that flows through the bypass channel 168 is forced to go through the conventional filter 172 which disturbs the direction of the air flow and slows the air down. Therefore, the air is traveling faster when it exits from the spinning disk 112 at position 176 than after it passes through the filter 172 at position 174. In order to compensate for the loss in speed due to going through the filter 172 the disk drive 110 consumes more electrical energy resulting in additional generation of heat.

Second, it is important that the actuator 140 be stable as the actuator is reading data or writing data. A measurement commonly known as tracks misregistration (TMR) is used for determining how far the read write head misses a track on a disk during a read or write operation. As can be seen, the more stable the actuator 140 is, the lower the TMR will be, and therefore data can be stored on a disk 112 at a higher density. However, since a conventional filter 172 causes turbulent air flow patterns, for example by causing too much turbulent air to pass by the actuator as described herein, the voice coil motor 150 has to work harder to keep the actuator 140 on track. This can result in a moderate increase in heat, for example, in a server farm with a hundred or more disk drives.

Third, the conventional filter 172 is typically limited in its ability to cleanup the environment inside of the disk drive 110. For example, the larger that the filter 172 is the better and the more quickly it 172 can clean up the environment inside of the disk drive 110. However, the space inside of a disk drive 110 is limited therefore the size of the filter 172 is limited. Further, the larger the filter obstruction of the bypass channel the harder the disk drive 110 will have to work to force the air through the filter 172. It has been found that the time constant effectiveness of a conventional filter 172 is limited to approximately 60 to 90 seconds due to the size restrictions of the conventional filter 172.

Therefore, there is a need for a disk drive filtering system that reduces the obstruction of air flow through a bypass channel associated with a disk drive and that does a better job of cleaning up the environment inside of the disk drive than the conventional filter 172. According to one embodiment, a filter is associated with a disk drive in a manner that the flow of air is substantially unobstructed, as will become more evident.

### Filters

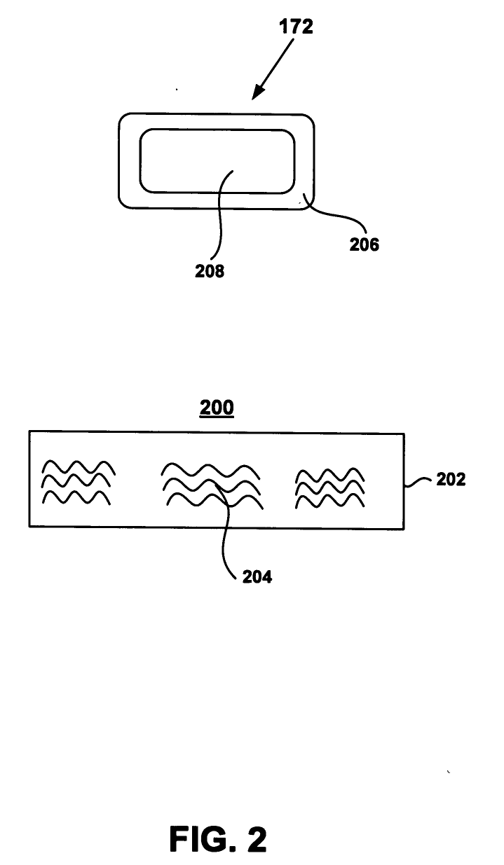

FIG. 2 depicts a conventional filter 172 and a pass-by filter 200 according to one embodiment of the present invention. The conventional filter 172 has a three dimensional shape due to edges 206 that are pressed together and a middle portion 208 that is not compressed together. In a conventional disk drive filtering system, air is forced to pass through the conventional filter 172. As can be seen, the surface area of the conventional filter 172 is considerably smaller than pass-by filter 200.

According to one embodiment, filter 200 is a pass-by filter because air can freely flow across the filter 200 rather than being forced through the filter 200. Therefore, as will become more evident, filter 200 can provide considerably more surface area for cleaning the environment.

Filter 200 can include a carrier 202, such as clean room paper. The filter 200 can have adhesive, such as pressure sensitive (PSA), on one or both sides. According to one embodiment, one of the adhesive sides can be used to attach the filter 200 to the disk drive. According to another embodiment, the filter 200 can be attached to the disk drive using slots or tabs instead of adhesive. Adhesive, slots and tabs are examples of holding structures that enable the filter to be attached to the disk drive.

Various filtering materials 204 such as material for filtering chemicals, electrostatic media and impact media can be associated with the filter 200. The impact media can be used for filtering relatively large particles that will collide into the filter 200. The electrostatic media can be used for filtering particles that are too small to cause collision. Typically electrostatic media has negative and positive charges. Therefore, the electrostatic media can attract negatively or positively charged particles that are too small to otherwise collide with the filter 200. Material for filtering chemicals, such as activated carbon, can filter chemical vapors such as hydrocarbons or fluorocarbons. The various filtering materials 204 can be attached to one of the adhesive sides of the filter 200 and the other adhesive side can be attached to the disk drive, as will become more evident. In another embodiment, various filtering materials 204 can be fused to the carrier 202 instead of using an adhesive.

In yet another embodiment, the filter 200 does not include a carrier 202, such as clean room paper. Instead the filtering materials 204 can be used to create the structure of the filter 200 for example by weaving the filtering materials together or by fusing the filtering materials together using heat and pressure. In still another embodiment, the filtering materials are fused together only at the outer edges so that the filter's middle is highly porous.

### A Disk Drive Filtering System that Reduces the Obstruction of Air Flow

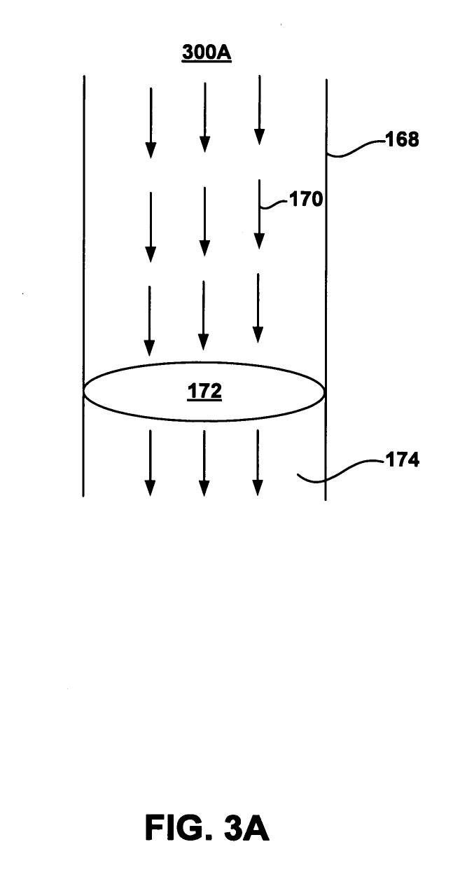

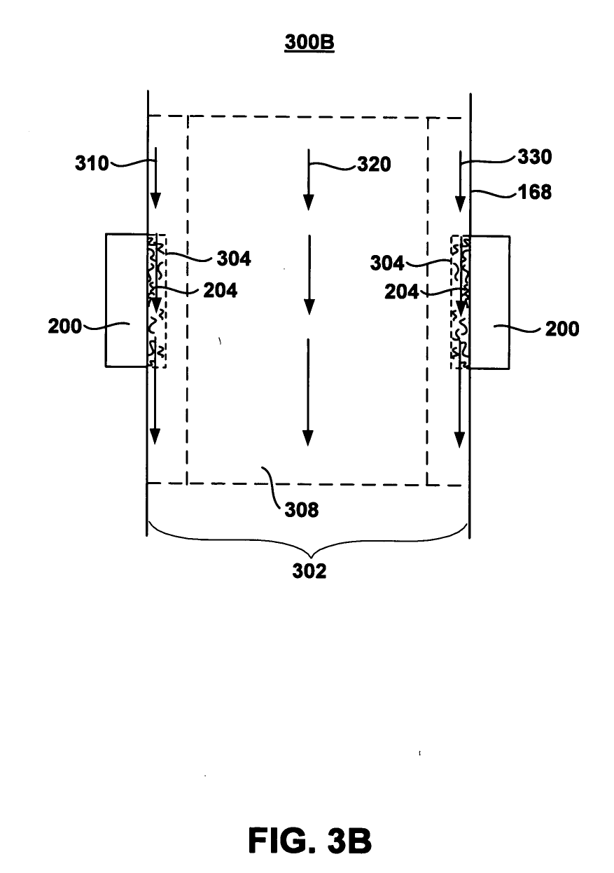

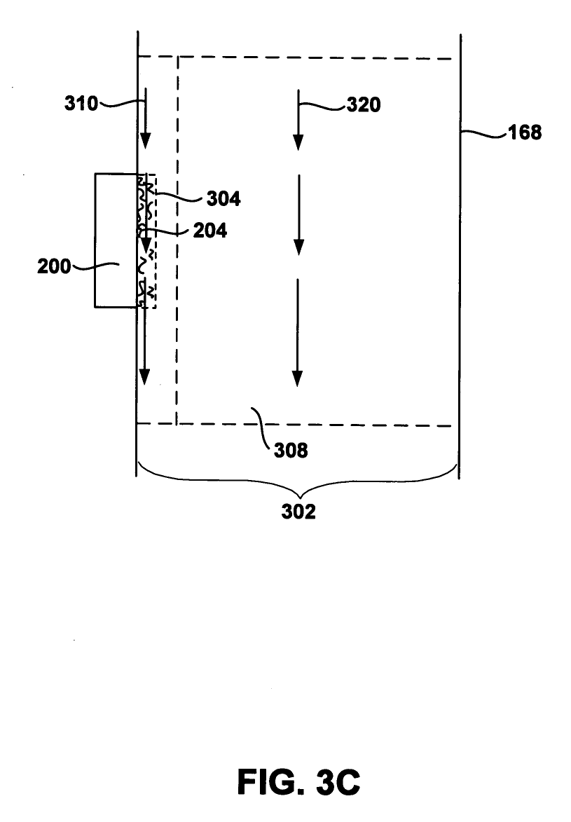

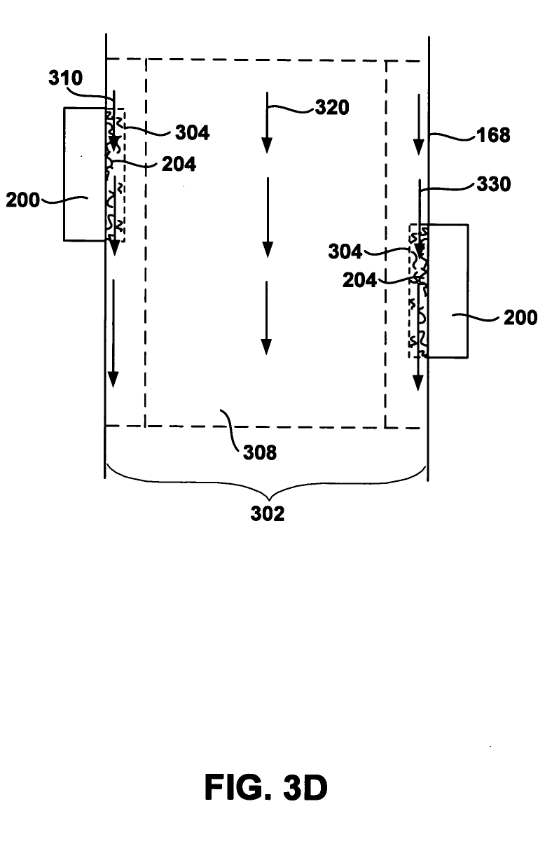

FIG. 3A depicts a conventional disk drive filtering system which obstructs the air flow through a bypass channel associated with a disk drive. FIG. 3A includes a conventional disk drive filtering system 300A with a conventional filter 172 that the air, as indicated by the arrows 170, is forced to flow through. The reference number 174 indicates a region in the bypass channel 168 after the air has been forced to flow through the conventional filter 172 and is about to re-enter the region where the disk 112 is spinning.

In contrast, FIG. 3B depicts a disk drive filtering system for reducing the obstruction of air flow through a bypass channel associated with a disk drive, according to one embodiment. The disk drive filtering system 300B includes a selective filtering region 302, pass-by filters 200, and a filter free region 308. The filters 200 that are associated with the disk drive filtering system 300B are pass-by filters because air can freely pass across the filter 200 rather than being forced through the filter 200. The selective filtering region 302 is disposed within a bypass channel 168. The selective filtering region 302 includes one or more filtering regions 304 where portions of air 310, 330 can be filtered and a filter free region 302 where another portion of air 320 is allowed to flow substantially unobstructed through the selective filtering region 302. When the selective filtering region 302 is placed in a high-pressure zone, many particles can be trapped by the filter as the air moves freely across the fibers of the filter. Alternatively, when the filter is in a low-pressure zone, particles may still be captured since the net trapping efficiency is high due to the large filter area associated with a bypass channel, according to one embodiment . . . In this way, both the high and low pressure zones of a disk drive can be used to trap particles. Further, when air flows substantially unobstructed through the selective filtering region 302 it stands to reason, according to one embodiment, that the air can flow substantially unobstructed through the bypass channel 168 which includes the selective filtering region 302.

Portions of air 310 and 330 are filtered by the filters 200, for example, as the portions of air 310, 330 flow through or proximate to the filtering materials 204 associated with the filters 200. The filter free region 308 is disposed proximate to the pass-by filters 200. Another portion of air 320 is allowed to flow substantially unobstructed through the filter free region 308 that is disposed within the selective filtering region 302.

Although the portions of air 310, 320, 330 are depicted with straight arrows, air typically swirls around as it flows within a bypass channel 168. Therefore, one set of air particles maybe in the filter free region 302 at one point in time and then be in a filtering region 304 at another point in time. However, it should still be evident to one of ordinary skill in the art that various embodiments of the present invention provide for air flow that is substantially unobstructed.

Although FIG. 3B depicts two filters 200 depicted on each side of a bypass channel 168 directly across from each other, filters 200 are not limited in how they 200 can be associated with the bypass channel 168. For example, one or more filters 200 may be attached to only one side of the bypass channel 168 or may not be directly across from each other. FIGS. 3C and 3D depict other ways that filters 200 can be associated with a bypass channel 168 and other orientations of various filtering regions 302, 304, 308.

### A Disk Drive that Reduces the Obstruction of Air Flow

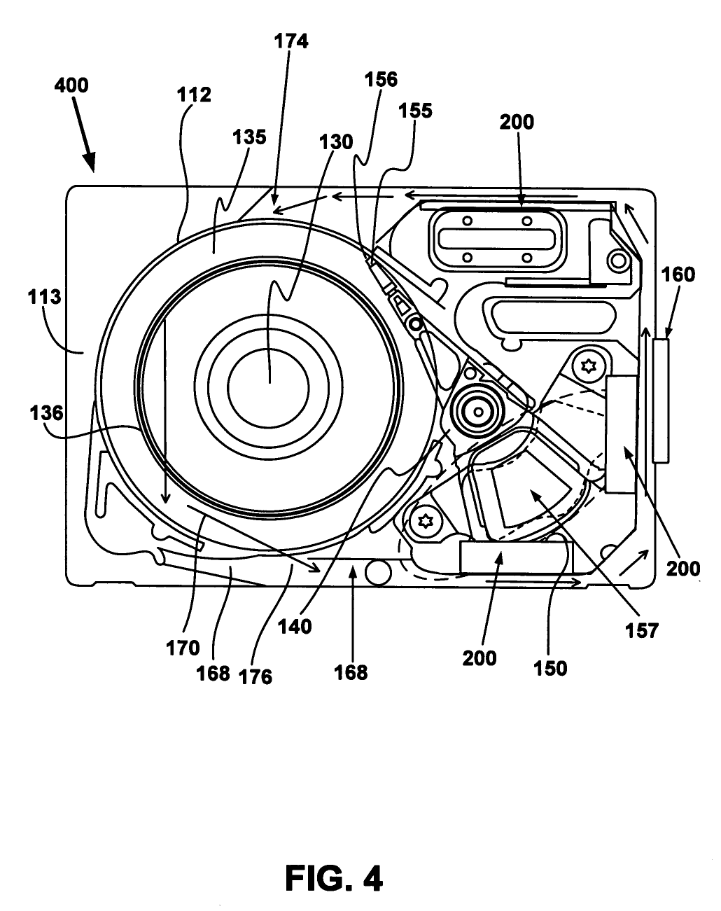

FIG. 4 depicts a disk drive for reducing obstruction of air flow through a bypass channel associated with the disk drive, according to one embodiment. The disk drive 400 depicted in FIG. 4 includes a base casting 113, a motor hub assembly 130, a disk 112, an actuator 140, a magnetic read write head 156, a slider 155, a motor hub assembly 130, a voice coil motor 150, a bypass channel 168, filters 200 and desiccant 160.

The air is not obstructed at position 174, as depicted in FIG. 4, by a filter because as can be seen the air is not forced to flow through a conventional filter 172 as depicted in FIG. 1. Therefore, the disk drive does not have to use more electrical energy to compensate due to the increase in airflow turbulence. The voice coil motor 157 also does not have to use more electrical energy to stabilize the actuator 140 due to the increase in airflow turbulence.

The filters 200, according to one embodiment, can be attached to the bypass channel 168 in various ways so that the air does not have to flow through the filters 200. As depicted in FIG. 4, filters 200 are attached to the sides that is adjacent to the voice coil motor 157 and to a side of the bypass channel 168. However, the filters 200 can be attached to the bypass channel 168 in a manner so that air will flow substantially unobstructed through the bypass channel 168. For example, filters 200 can be attached to almost any surface inside of a disk drive. More specifically, the filters 200 could be attached to the side or bottom of the bypass channel 168, to the side adjacent to the voice coil motor 157, to the cover of the disk drive or to a combination of places, among other areas. In yet another embodiment, a filter 200 is used to create the pass-by filter that includes the full surface cover of the disk drive. For example, the cover of the disk drive can be made in part or entirely of a filter 200. For example, filtering materials can be fused or weaved together and shaped into the full surface of the cover. In another example, filtering materials can be deposited onto a cover for example by spraying the filtering materials onto the cover. The spray may include an adhesive.

As already stated, the effectiveness of a filter to cleanup the environment inside of a disk drive is directly proportional to the size of the filter. Further, the space inside of a disk drive is limited. Therefore, the size of a conventional filter 172 as depicted in FIG. 1 is limited. However, the surface area of a filter 200 can be much greater than the surface area of the conventional filter 172 because, among other things, the air flow 170 is not forced through the filter 200. Therefore, the effectiveness of a filter 200, according to various embodiments, is much higher than that of conventional filters 172. In fact, one or more filters can be placed in many places in a disk drive 400. For example, the cover of one disk drive 400 could be one continuous filter. Another filter could run all along the edges of the voice coil motor and yet another filter could run along the edge of the base casting, among other places, thus providing a large surface area for filtering contaminants, such as particles and vapors.

### Operational Example of a Method of Manufacturing Disk Drive Filtering Systems that Reduce Obstruction of Air Flow Through a Bypass Channel

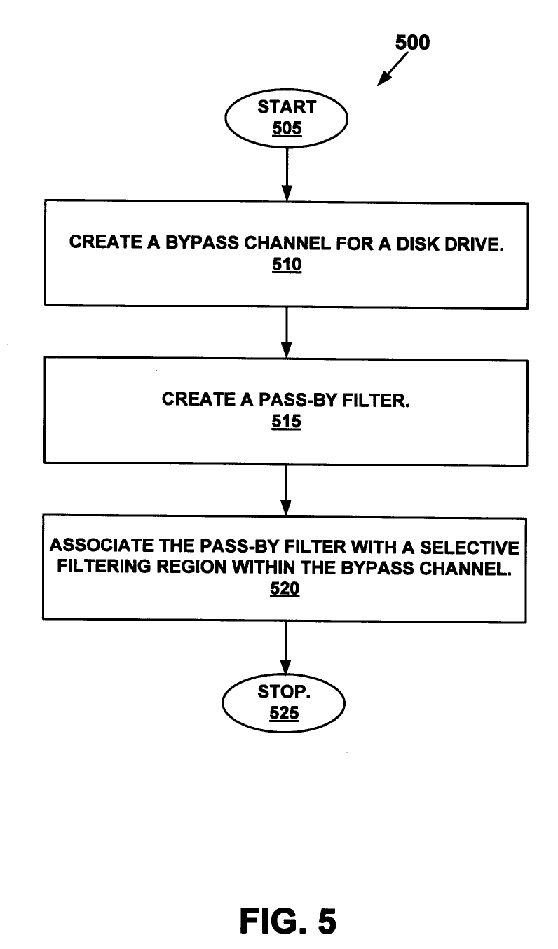

FIG. 5 depicts a flowchart 500 describing a method of manufacturing a disk drive filtering system that reduces obstruction of air flow through a bypass channel associated with a disk drive, according to one embodiment of the present invention. Although specific steps are disclosed in flowchart 500, such steps are exemplary. That is, embodiments of the present invention are well suited to performing various other steps or variations of the steps recited in flowchart 500. It is appreciated that the steps in flowchart 500 may be performed in an order different than presented, and that not all of the steps in flowchart 500 may be performed.

All of, or a portion of, the embodiments described by flowchart 500 can be implemented using computer-readable and computer-executable instructions which reside, for example, in computer-usable media of a computer system or like device. As described above, certain processes and steps of the present invention are realized, in one embodiment, as a series of instructions (e.g., software program) that reside within computer readable memory of a computer system and are executed by the computer system. When executed, the instructions cause the computer system to implement the functionality of the present invention as described below.

In step 505, the process begins.

In step 510, a bypass channel is created for the disk drive. For example, a bypass channel 168 is created by creating an enclosure for the disk drive 400 with a shape that provides the bypass channel 168. Further, various components such as the voice coil motor 157, the motor hub assembly 150 and the disks 135 are assembled in the disk drive 400 in a manner that provides for the demarcation of the bypass channel 168. Air can flow 170 through the bypass channel 168.

In step 515, a pass-by filter is created. For example, assume that a filter 200 includes a carrier 202, such as clean room paper, has adhesive on both sides, and filtering materials 204 are attached to one of the adhesive sides.

In step 520, the pass-by filter can be associated with a selective filtering region within the bypass channel. For example, the other adhesive side of the filter 200 can be used to attach the filter to the bypass channel 168. Referring now to FIG. 3C, the pass-by filter 200 can filter a first portion of air 310 that flows through the selective filtering region 302. A filter free region 308 is disposed proximate to the pass-by filter 200 so that a second portion of air 320 is allowed to flow substantially unobstructed through the selective filtering region 302.

In step 525, the process ends.

### CONCLUSION

According to various embodiments of the present invention, pass-by filters can be used to allow air to flow substantially unobstructed through a bypass channel of a disk drive. Therefore, less heat is generated, the TMR is lowered so more data can be stored on a disk drive, and the environment of a disk drive can be cleaned more quickly and remain cleaner, among other things, than is the case with disk drives using conventional filters. The reduction in heat and the cleaner environment results in a longer life time for a disk drive and a lower probability of losing data, among other things. Further, a company that can manufacture disk drives with higher reliability, longer life time, or a higher density of data is positioned to be more profitable and deliver a more competitive product.

The conventional filter 172 has been used for a long time without significant changes in its design other than varying its size. Therefore, there has been a long felt need for the reduction in generated heat, the higher density of stored data, and the cleaner environment provided by a filter manufactured according to various embodiments of the present invention.

Further, the results provided by a filter manufactured according to various embodiments of the present invention are evident by experiment or simulation. Typically, the industry has provided a cleaner environment inside of a disk drive by making the conventional filter 172 bigger. However, this resulted in taking up valuable space inside of the disk drive and in further obstruction of the air flow 170. Therefore, the industry has had a difficult time finding a way to simultaneously solve all of the problems that can be solved by filters manufactured according to various embodiments of the present invention.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A disk drive filtering system for reducing the obstruction of air flow through a bypass channel associated with a disk drive, the disk drive filtering system comprising:
a selective filtering region disposed within a bypass channel;
a pass-by filter disposed within the selective filtering region, wherein the pass-by filter is configured to filter a first portion of the air that flows through the selective filtering region; and
a filter free region disposed proximate to the pass-by filter, wherein a second portion of the air is allowed to flow substantially unobstructed through the selective filtering region.

2. The disk drive filtering system of claim 1, further comprising:
a holding structure that enables the filter to be attached to the bypass channel in a manner that the second portion of the air is allowed to flow substantially unobstructed through the selective filtering region.

3. The disk drive filtering system of claim 2, wherein the holding structure is selected from a group consisting of adhesive, a tab, and a slot.

4. The disk drive filtering system of claim 1, wherein the pass-by filter includes a carrier that filtering materials can be associated with.

5. The disk drive filtering system of claim 4, wherein the filtering materials are selected from a group consisting of chemical filtering materials, electrostatic media and initial impact media.

6. The disk drive filtering system of claim 1, wherein the pass-by filter is created by a method selected from a group consisting of weaving materials together, fusing materials associated with the pass-by filter together at the outer edges, attaching filtering materials in the form of fibers to a carrier.

7. The disk drive filtering system of claim 1, wherein the pass-by filter is comprised of the full surface of the disk drive cover.

8. The disk drive filtering system of claim 1, wherein the pass-by filter is attached to a disk drive component that is proximate to the selective filtering region selected from the group consisting of a voice coil motor, a base casting, and a cover.

9. A method of manufacturing a disk drive filtering system that reduces obstruction of air flow through a bypass channel associated with a disk drive, the method comprising:
creating a bypass channel for the disk drive, wherein the air flows through the bypass channel;
creating a pass-by filter;
associating the pass-by filter with a selective filtering region within the bypass channel, wherein the pass-by filter filters a first portion of the air that flows through the selective filtering region and wherein a filter free region is disposed proximate to the pass-by filter so that a second portion of the air is allowed to flow substantially unobstructed through the selective filtering region

10. The method as recited in claim 9, wherein the creating of the pass-by filter further comprises:
associating filtering materials with a carrier using a method selected from a group consisting of fusing the filtering materials to the carrier, using an adhesive to attach the filtering materials to the carrier, and weaving the filtering materials into the carrier.

11. The method as recited in claim 9, wherein the creating of the pass-by filter further comprises:
using filtering materials to create a full surface cover for the disk drive.

12. The method as recited in claim 11, wherein the using of the filtering materials to create the full surface cover for the disk drive further comprises:
using a method to create the cover selected from a group consisting of fusing the filtering materials together and weaving the filtering materials.

13. The method as recited in claim 9, wherein the associating of the pass-by filter with the selective filtering region further comprises:
attaching the pass-by filter to a disk drive component that is proximate to the bypass channel selected from the group consisting of a voice coil motor, a base casting, a cover, slit shroud, air diffuser, and airflow-spoiler system.

14. A disk drive for reducing obstruction of air flow through a bypass channel associated with the disk drive, the disk drive comprising:
a selective filtering region disposed within a bypass channel;
a pass-by filter disposed within the selective filtering region, wherein the pass-by filter for filtering a first portion of the air that flows through the selective filtering region; and
a filter free region disposed proximate to the pass-by filter, wherein a second portion of the air is allowed to flow substantially unobstructed through the selective filtering region

15. The disk drive of claim 14, further comprising:
a holding structure that enables the filter to be attached to the bypass channel in a manner that the second portion of the air is allowed to flow substantially unobstructed through the selective filtering region, wherein the holding structure is selected from a group consisting of adhesive, a tab, and a slot.

16. The disk drive of claim 14, wherein the pass-by filter includes a carrier that filtering materials can be associated with.

17. The disk drive of claim 16, wherein the filtering materials are selected from a group consisting of chemical filtering materials, electrostatic media and initial impact media.

18. The disk drive of claim 14, wherein the pass-by filter is created by a method selected from a group consisting of weaving materials together, fusing materials associated with the pass-by filter together at the outer edges, attaching filtering materials in the form of fibers to a carrier.

19. The disk drive of claim 14, wherein the pass-by filter is created in the form of a full surface cover for the disk drive.

20. The disk drive of claim 19, wherein a method to create the cover is selected from a group consisting of fusing the filtering materials together and weaving the filtering materials.
